(19) United States
(12) Patent Application Publication
(10) Pub. No.: US 2025/0336197 A1
(43) Pub. Date: Oct. 30, 2025

(54) MODEL GENERATION METHOD, OBJECT DETECTION METHOD, CONTROLLER AND ELECTRONIC DEVICE

(71) Applicant: THIRD REALITY, INC., Zhenjiang, Jiangsu (CN)

(72) Inventors: Xuezhang DONG, Zhenjiang, Jiangsu (CN); Chunsheng YU, Zhenjiang, Jiangsu (CN)

(21) Appl. No.: 18/992,483

(22) PCT Filed: Jul. 26, 2022
(86) PCT No.: PCT/CN2022/107858

§ 371 Date: Jan. 8, 2025

(51) Int. Cl. G06V 10/82; G06V 10/77; G06V 10/774

(52) U.S. Cl. CPC G06V 10/82; G06V 10/7715; G06V 10/7753

(57) ABSTRACT

This invention provides a model generation method, an object detection method, a controller, and an electronic device. The model generation method comprises: constructing a convolutional neural network model used for multi-scale object detection, and dividing the convolutional neural network model into a plurality of modules, the plurality of modules comprising a feature extraction module and a plurality of detection head modules of different scales; using unlabeled training data to pre-train the feature extraction module to obtain parameters and models of the feature extraction module; and connecting the trained feature extraction module to the plurality of detection head modules respectively, and using labeled training data to train a plurality of the modules which have been connected, to obtain parameters and models of the modules. A high-precision convolutional neural network model can be obtained without the need to label a large amount of training data, and the labor and time required for labeling the training data are saved.

### TECHNICAL FIELD

The present invention relates to the field of image processing technology, and specifically to a model generation method, an object detection method, a controller and an electronic device.

### BACKGROUND

With the advancement of computer hardware technology, deep learning models can run on the latest 32-bit microcontrollers. The power consumption of existing commonly used microcontrollers (MCUs) is only a few milliwatts. Based on the low power consumption features of microcontrollers, devices using microcontrollers can be powered by button batteries or some solar cells. Microcontrollers are an important part of the development of the Internet of Things. The real-time operating system (RTOS) has been widely used on the STM32 platform of STMicroelectronics, the ESP32 platform of Espressif Systems, and Arduino platform: the real-time operating system enables the microcontroller to support multi-processors (CPU), multi-threaded applications.

Object Detection is to give a picture, separate a target of interest from the background, and determine the category and location of this target: that is, for a given image, determine the category and location of the target contained in the image. A convolutional neural network (CNN) for image classification based on deep learning is a feed-forward neural network where its artificial neurons can respond to surrounding units within a part of the coverage area and have excellent performance in large-scale image processing. The convolutional neural network model architecture is a multi-layer structure, wherein after the first input layer, the image has several convolutional layers, batch normalization layers, and downsampling layers arranged in various orders, finally, the output layer outputs the category and location of the target in the image.

The more convolutional layers of the convolutional neural network model, the higher its representation ability: However, the more layers of the convolutional neural network model, the more parameters involved. For example, the image classification model MobilenetV2 that can be used in mobile phones has about 3.5 M parameters, but the current microcontroller has only about 256 KB to 512 KB on-chip memory. MobilenetV2 cannot be used in the microcontroller, so only image classification convolutional neural networks with fewer layers can be run on the microcontroller.

### SUMMARY

An object of the present invention is to provide a model generation method, an object detection method, a controller and an electronic equipment, which can obtain a high-precision convolutional neural network model without the need to label a large amount of training data, and save the labor and time required for labeling the training data.

In order to achieve the above object, the present invention provides a model generation method, comprising: constructing a convolutional neural network model for multi-scale object detection, and dividing the convolutional neural network model into a plurality of modules, and the plurality of modules includes: a feature extraction module and several detection head modules of different scales; using unlabeled training data to pre-train the feature extraction module to obtain parameters and models of the feature extraction module; connecting the trained feature extraction module to a plurality of the detection head modules respectively, and using labeled training data to train a plurality of the modules which have been connected, to obtain parameters and models of the modules.

The present invention also provides an object detection method, applied to a controller, the method comprises: obtaining a convolutional neural network model for performing multi-scale object detection on images to be detected, and the convolutional neural network model is generated based on the above-mentioned model generation method; using the convolutional neural network model to perform object detection on the images to be detected.

The present invention also provides a controller for executing the above-mentioned model generation method and/or the above-mentioned object detection method.

The invention also provides an electronic device, comprising: the above-mentioned controller and a memory communicatively connected with the controller.

This embodiment provides a model generation method, firstly, constructing a convolutional neural network model for multi-scale object detection, and dividing the convolutional neural network model into a plurality of modules, the plurality of modules includes: a feature extraction module and several detection head modules of different scales; and then using the unlabeled training data to pre-train the feature extraction module to obtain the parameters and models of the feature extraction module, so that the feature extraction module learns features of the unlabeled training data in advance, and then combining the trained feature extraction module with a plurality of the detection head modules of different scales to obtain the convolutional neural network model, and using the labeled training data to train the combined convolutional neural network model including a plurality of the modules (including the feature extraction module and the detection head module) to obtain the parameters and models of the modules (including the feature extraction module and the detection head module), since the feature extraction module has learned the features of the unlabeled training data in advance, at this time, it is possible to use only a small amount of labeled training data to perform supervised learning training on the combined convolutional neural network model to obtain the final convolutional neural network model, a high-precision convolutional neural network model can be obtained without the need to label a large amount of training data, and the labor and time required for labeling the training data are saved.

In one embodiment, the using unlabeled training data to pre-train the feature extraction module to obtain parameters and models of the feature extraction module, includes: using the feature extraction module as an encoding module of an autoencoder to design a decoding module of the autoencoder, and using unlabeled training data to train the autoencoder to obtain the parameters and models of the feature extraction module.

In one embodiment, for each of the modules, the memory occupied by the parameters of the module corresponding to the multi-layer structure model is less than the on-chip storage of the controller running the convolutional neural network model.

In one embodiment, after the connecting the trained feature extraction module to a plurality of the detection head modules respectively, and using labeled training data to train a plurality of the modules which have been connected, to obtain parameters and models of the modules, the method further includes: converting the parameters and models of the modules into a format for running on the controller respectively.

In one embodiment, the constructing a convolutional neural network model for object detection, includes: based on the attributes of the image to be detected and the system parameters of the controller, generating the convolutional neural network model for performing object detection on the images to be detected.

In one embodiment, in the obtained convolutional neural network model, the memory occupied by the parameters of each of the modules corresponding to the multi-layer structure model is less than the on-chip storage of the controller; the using the convolution neural network model to perform object detection on the images to be detected, includes: running a plurality of modules included in the convolutional neural network model in parallel in multiple threads of the controller, and performing object detection on the images to be detected.

In one embodiment, in the obtained convolutional neural network model, the memory occupied by the parameters of each of the modules corresponding to the multi-layer structure model is less than the on-chip storage of the controller; the using the convolution neural network model to perform object detection on the images to be detected, includes: running a plurality of modules included in the convolutional neural network model in parallel in multiple processors of the controller, and performing object detection on the images to be detected.

### BRIEF DESCRIPTION OF DRAWINGS

FIG. 1 is a specific flow chart of a model generation method according to the first embodiment of the present invention;

FIG. 2 is a schematic diagram of a convolutional neural network model according to the first embodiment of the present invention;

FIG. 3 is a flow chart of step 102 of the model generation method in FIG. 1;

FIG. 4 is a specific flowchart of an object detection method according to the second embodiment of the present invention.

### DETAILED DESCRIPTION OF PREFERRED EMBODIMENTS

Each embodiment of the present application will be described in detail hereinafter in conjunction with the accompanying drawings for a clearer understanding of the purposes, features and advantages of the present application. It should be understood that the embodiments shown in the accompanying drawings are not intended to be a limitation of the scope of the present application, but are merely intended to illustrate the substantive spirit of the technical solution of the present application.

In the following description, certain specific details are set forth for the purpose of illustrating various disclosed embodiments to provide a thorough understanding of various disclosed embodiments. However, those skilled in the related art will recognize that embodiments may be practiced without one or more of these specific details. In other cases, familiar devices, structures, and techniques associated with the present application may not be shown or described in detail so as to avoid unnecessarily confusing the description of the embodiments.

Unless the context requires otherwise, throughout the specification and the claims, the words “including” and variants thereof, such as “comprising” and “having”. are to be understood as open-ended and inclusive meaning, i.e., should be interpreted as “including, but not limited to”.

References to “one embodiment” or “an embodiment” throughout the specification indicate that a particular feature, structure, or characteristic described in conjunction with an embodiment is included in at least one embodiment. Therefore. the occurrence of “in one embodiment” or “in an embodiment” at various locations throughout the specification need not all refer to the same embodiment. In addition. particular features, structures or characteristics may be combined in any manner in one or more embodiments.

As used in the specification and in the appended claims, the singular forms “a” and “an” include plural referents, unless the context clearly provides otherwise. It should be noted that the term “or” is normally used in its inclusive sense of “or/and”. unless the context clearly provides otherwise.

In the following description, in order to clearly show the structure and working method of this application, it will be described with the help of many directional words, but words such as “front”, “back”, “left”, “right”, “outside”, “inside”, “outward”, “inward”, “up”, “down”, and the like should be understood as convenient terms and not as limiting terms.

The first embodiment of the present invention relates to a model generation method for training a generated convolutional neural network model. The trained convolutional neural network can be used for multi-scale object detection in images.

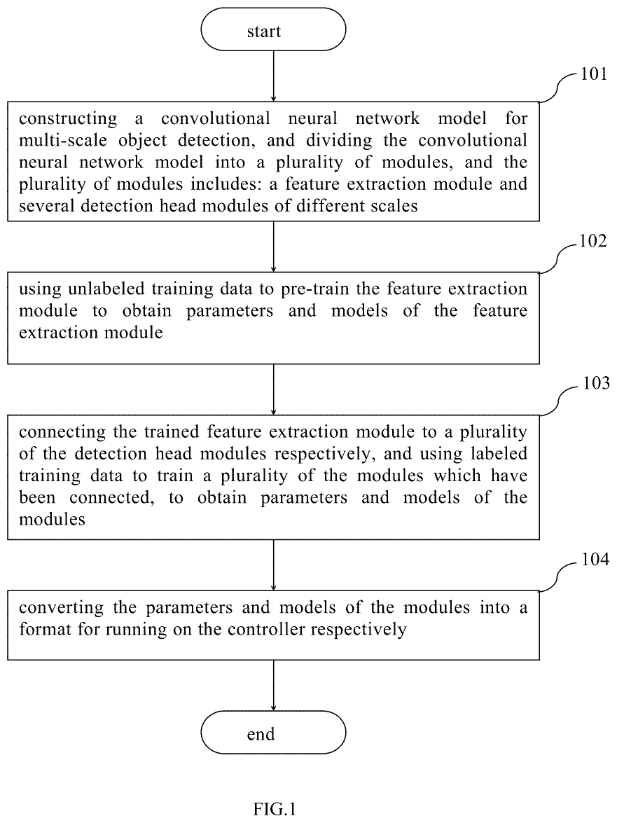

The specific flowchart of the model generation method in this embodiment is shown in FIG. 1.

Step 101: constructing a convolutional neural network model for multi-scale object detection, and dividing the convolutional neural network model into a plurality of modules, the plurality of modules includes: a feature extraction module and several detection head modules of different scales.

Specifically, the convolutional neural network model is used for multi-scale object detection, which can be constructed based on the attributes of the images to be detected and the parameters of the controller running the convolutional neural network model, and the constructed convolutional neural network model can be used for multi-scale object detection, that is, the convolutional neural network model includes a plurality of detection heads, for example, for an image to be detected, if it is necessary to perform 1×1, 2×2, 3×3 and 4×4 scales object detection on the image to be detected, the constructed convolutional neural network model includes a 1×1 scale detection head, a 2×2 scale detection head, a 3×3 scale detection head and a 4×4 scale detection head.

After constructing a convolutional neural network model for multi-scale detection, the multi-layer structure of the convolutional neural network model is sequentially divided into a plurality of modules, which include: a feature extraction module and several detection head modules of different scales; the feature extraction module is used to extract features from the input image to be detected, and each detection head module is used for object detection of corresponding scales. Wherein each module includes a plurality of layers of the convolutional neural network model, after a plurality of modules are combined, a complete convolutional neural network model can be obtained. Wherein, the controller can be an MCU microcontroller.

In one example, for each module, the memory occupied by the parameters of the module corresponding to the multi-layer structure model is less than the on-chip storage of the controller running the convolutional neural network model. That is, when dividing the convolutional neural network model, it is necessary to ensure that the memory occupied by the parameters of each divided module corresponding to the multi-layer structure module is less than the on-chip storage of the controller to ensure that a single module can be run on the controller; moreover, later a plurality of modules may be selected to be run in parallel in multiple threads in the controller, or for a controller including multiple processors, a plurality of modules can be run in parallel in multiple processors, that is, the feature extraction module and the detection head modules are run in different threads or processors, thus accelerating the computing speed of the controller and improving the speed of performing object detection on the image to be detected.

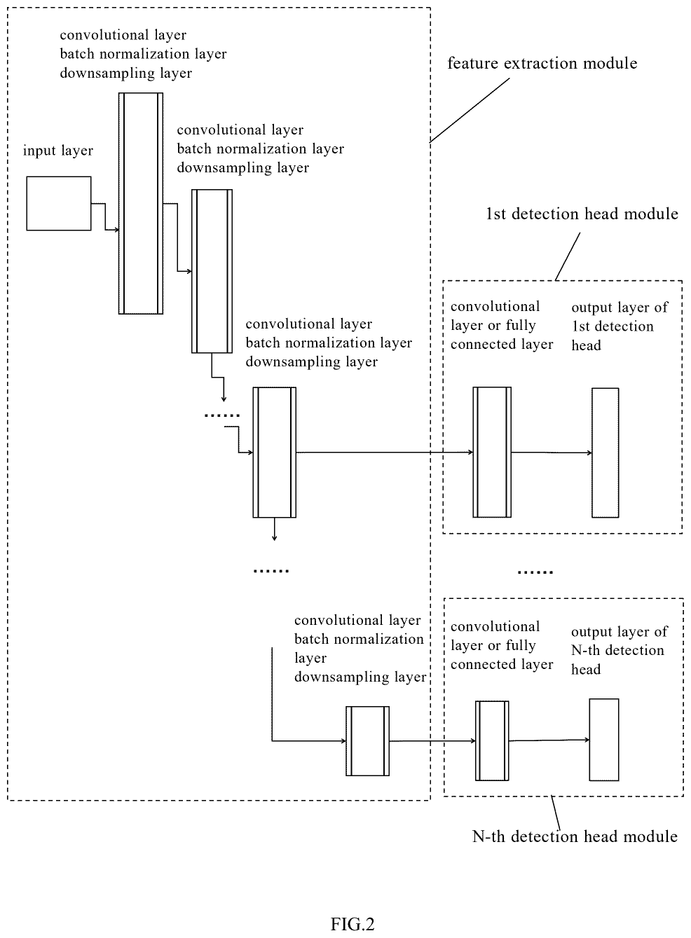

Taking the convolutional neural network model in FIG. 2 as an example, the convolutional neural network model includes an input layer for receiving input images; after the input layer, there are arranged several convolutional layers, batch normalization layers and downsampling layers for feature extraction; the convolutional neural network includes N detection heads of different scales, the features extracted by the feature extraction module are connected to the output layer of the detection heads of each scale through a fully connected layer or a convolution layer, and the output layer of each detection head outputs the category of the object in the image.

When dividing the convolutional neural network model in FIG. 2, cascading the output layer with several groups of convolutional layers, batch normalization layers and downsampling layers used for feature extraction to form a feature extraction module, and the output layers of detection heads of each scale and the adjacent fully connected layer or convolution layer form a detection head module, so as to obtain N detection head modules of different scales, where N is an integer greater than 1; that is, the convolutional neural network model can be divided into one feature extraction module and N Detection head modules of different scales.

Step 102: using unlabeled training data to pre-train the feature extraction module to obtain parameters and models of the feature extraction module.

Specifically, after completing the division of the convolutional neural network model in step 101, the feature extraction module is pre-trained using unlabeled data. and the parameters and models of the feature extraction module are obtained and saved, wherein the parameters of the feature extraction module include connection weights between layers in the feature extraction module.

In an example, referring to FIG. 3. Step 102 using unlabeled training data to pre-train the feature extraction module to obtain the parameters and models of the feature extraction module, includes: using the feature extraction module as an encoding module of an autoencoder to design an decoding module of the autoencoder. and using the unlabeled training data to train the autoencoder to obtain the parameters and models of the feature extraction module.

Taking the convolutional neural network model in FIG. 2 as an example, training the feature extraction module obtained by dividing the convolutional neural network model, firstly; using the feature extraction module as the encoding module 11 of the autoencoder to design the decoding module 12 of the autoencoder, thus the encoding module 11 (feature extraction module) and the decoding module 12 form the autoencoder, since the autoencoder belongs to unsupervised learning and does not rely on the labeling of training data, it is possible to automatically find the relationship among the training data by mining the intrinsic features of the training data, so that the autoencoder can be trained using unlabeled training data: inputting the unlabeled training data to the encoding module 11 (feature extraction module), and using the encoding module 11 (feature extraction module) to map the training data to a feature space, and then using the decoding module 12 to map the sampling features obtained by the encoding module 11 (feature extraction module) back to the original space to obtain reconstructed data, and then comparing the reconstructed data with the training data to obtain the reconstruction error, and optimizing the encoding module 11 (feature extraction module) and decoding module 12 with minimizing the reconstruction error as the optimization goal, so as to obtain the final required encoding module 11 (feature extraction module), and saving the parameters and models of the encoding module 11 (feature extraction module), the encoding module 11 (feature extraction module) learns to obtain an abstract feature representation for the training data input.

Step 103: connecting the trained feature extraction module to a plurality of detection head modules respectively, and using the labeled training data to train a plurality of the modules which have been connected, to obtain the parameters and models of the modules.

Specifically, after the above-mentioned pre-training of the feature extraction module, combining the feature extraction module with a plurality of untrained detection head modules to obtain a complete convolutional neural network model, and then using the labeled training data to perform supervised learning training on the combined convolutional neural network model, and since the feature extraction module has learned the features of the training data in step 102, only a small amount of labeled training data is needed to perform upervised learning training on the convolutional neural network in this step, after completing the training of the combined convolutional neural network model, obtaining the final convolutional neural network model, and saving the parameters and models of the feature extraction module and the detection head modules respectively.

In one example, after step 103, the method further comprises:

Step 104: converting the parameters and models of the modules into a format for running on the controller respectively.

Specifically, after saving the final parameters and models of the feature extraction module and the detection head modules in step 103, converting the parameters and models of the feature extraction module and the detection head modules respectively, so that the feature extraction module and the detection head modules can be run on the controller: for example, the parameters and models of the feature extraction module and the detection head modules are converted into code forms, so that the feature extraction module and each detection head module can be compiled directly in the controller, which reduces the memory occupation of the modules in the controller and improves the running speed.

This embodiment provides a model generation method, firstly, constructing a convolutional neural network model for multi-scale object detection, and dividing the convolutional neural network model into a plurality of modules, the plurality of modules include: feature extraction module and several detection head modules of different scales: and then using the unlabeled training data to pre-train the feature extraction module to obtain the parameters and models of the feature extraction module, so that the feature extraction module learns features of the unlabeled training data in advance, and then combining the trained feature extraction module with a plurality of the detection head modules of different scales to obtain the convolutional neural network model, and using the labeled training data to train the combined convolutional neural network model including a plurality of the modules (including the feature extraction module and the detection head module) to obtain the parameters and models of the modules (including the feature extraction module and the detection head module), since the feature extraction module has learned the features of the unlabeled training data in advance, at this time, it is possible to use only a small amount of labeled training data to perform supervised learning training on the combined convolutional neural network model to obtain the final convolutional neural network model, a high-precision convolutional neural network model can be obtained without the need to label a large amount of training data, and the labor and time required for labeling the training data are saved.

The second embodiment of the present invention discloses an object detection method, which is applied to a controller (which may be an MCU microcontroller), a convolutional neural network model for performing multi-scale object detection on images is run in the controller, so that it can identify the target objects of multiple scales contained in the input image to be detected.

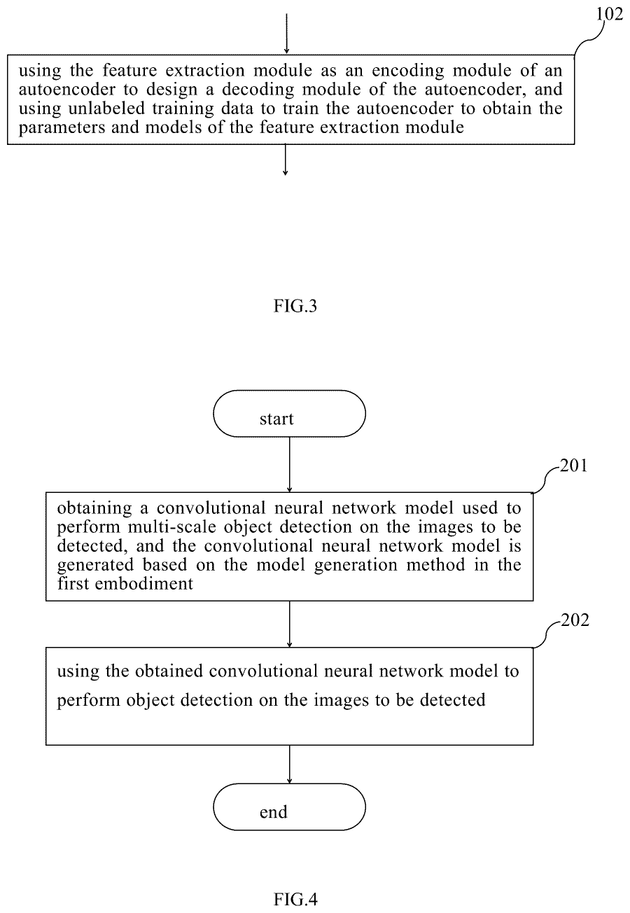

The specific process of the object detection method in this example is shown in FIG. 4.

Step 201: obtaining a convolutional neural network model for performing multi-scale object detection on images to be detected, the convolutional neural network model is generated based on the model generation method in the first embodiment.

Specifically, the convolutional neural network model for object detection is generated based on the model generation method in the first embodiment, the convolutional neural network model can be run in the controller after being generated.

Step 202: using the convolutional neural network model to perform object detection on the images to be detected.

In one example, in the obtained convolutional neural network model, the memory occupied by the parameters of each module corresponding to the multi-layer structure model is less than the on-chip storage of the running controller; using the convolutional neural network model to perform object detection on the images to be detected, includes: running a plurality of modules included in the convolutional neural network model in parallel in multiple threads or processors of the controller to perform object detection on the images to be detected. That is, in the convolutional neural network model generated in the first embodiment, the memory required for running each module of the convolutional neural network model (including the feature extraction module and the detection head module of multiple scales) is less than the on-chip storage of the controller, so that each module can run in the controller. and then a plurality of modules may be selected to be run in parallel in multiple threads in the controller, or for controllers including multiple processors, a plurality of modules is run in parallel in multiple processors. That is, the feature extraction module and the detection head modules run in different threads or processors respectively, which can accelerate the operational speed of the controller and improve the speed of performing object detection on the images to be detected. For example. the feature extraction module and the detection head modules are run in different processors respectively, after completing the feature extraction of the current image. the processor running the feature extraction module inputs the extracted features into the processor running the detection head modules, and then the processor running the feature extraction module can perform collection and feature extraction of the next image.

The third embodiment of the present invention discloses a controller, such as an MCU controller, which is used for executing the model generation method in the first embodiment and/or the object detection method in the second embodiment, that is, the controller can run the model generation method and the object detection method at the same time, or the model generation method and the object detection method are implemented by different controllers, for example, a model training process required higher computing power involved in the model generation method can be handed by the controller with higher processing power, the controller sends the generated convolutional neural network model to the microcontroller, and the microcontroller performs multi-scale object detection on the image to be detected based on the convolutional neural network.

The fourth embodiment of the present invention discloses an electronic device, which includes the controller in the third embodiment and a memory communicatively connected to the controller.

Preferred embodiments of the present invention have been described in detail above, but it should be understood that aspects of the embodiments can be modified to employ aspects, features and ideas from various patents, applications and publications to provide additional embodiments, if desired.

These and other variations to the embodiments can be made in view of the detailed description above. Generally, in the claims, the terms used should not be considered as limiting the specific embodiments disclosed in the specification and claims, but should be understood to include all possible embodiments together with the full scope of equivalents enjoyed by those claims.

1. A model generation method, wherein comprising:
constructing a convolutional neural network model for multi-scale object detection, and dividing the convolutional neural network model into a plurality of modules, and the plurality of modules includes: a feature extraction module and several detection head modules of different scales;
using unlabeled training data to pre-train the feature extraction module to obtain parameters and models of the feature extraction module;
connecting the trained feature extraction module to a plurality of the detection head modules respectively, and using labeled training data to train a plurality of the modules which have been connected, to obtain parameters and models of the modules.

2. A model generation method according to claim 1, wherein the using unlabeled training data to pre-train the feature extraction module to obtain parameters and models of the feature extraction module, comprises:
using the feature extraction module as an encoding module of an autoencoder to design a decoding module of the autoencoder, and using unlabeled training data to train the autoencoder to obtain the parameters and models of the feature extraction module.

3. A model generation method according to claim 1, wherein for each of the modules, the memory occupied by the parameters of the module corresponding to the multi-layer structure model is less than the on-chip storage of the controller running the convolutional neural network model.

4. A model generation method according to claim 1, wherein after the connecting the trained feature extraction module to a plurality of the detection head modules respectively, and using labeled training data to train a plurality of the modules which have been connected, to obtain parameters and models of the modules, the method further comprises:
converting the parameters and models of the modules into a format for running on the controller respectively.

5. A model generation method according to claim 1, wherein the constructing a convolutional neural network model for object detection, comprises:
based on the attributes of the image to be detected and the system parameters of the controller, generating the convolutional neural network model for performing object detection on the images to be detected.

6. An object detection method, wherein it is applied to a controller, the method comprises:
obtaining a convolutional neural network model for performing multi-scale object detection on images to be detected, and the convolutional neural network model is generated based on the model generation method according to claim 1;
using the convolutional neural network model to perform object detection on the images to be detected.

7. An object detection method according to claim 6, wherein in the obtained convolutional neural network model, the memory occupied by the parameters of each of the modules corresponding to the multi-layer structure model is less than the on-chip storage of the controller; the using the convolution neural network model to perform object detection on the images to be detected, comprises:
running a plurality of modules included in the convolutional neural network model in parallel in multiple threads of the controller, and performing object detection on the images to be detected.

8. An object detection method according to claim 6, wherein in the obtained convolutional neural network model, the memory occupied by the parameters of each of the modules corresponding to the multi-layer structure model is less than the on-chip storage of the controller; the using the convolution neural network model to perform object detection on the images to be detected, comprises:
running a plurality of modules included in the convolutional neural network model in parallel in multiple processors of the controller, and performing object detection on the images to be detected.

9. A controller, wherein it is used for executing the model generation method according to claim 1.

10. An electronic device, wherein comprising:
the controller according to claim 9 and a memory communicatively connected with the controller.
